(19) United States
(12) Patent Application Publication
(10) Pub. No.: US 2024/0198436 A1
(43) Pub. Date: Jun. 20, 2024

(54) MULTI-GROOVE PAGODA DRILL BIT

(71) Applicant: DANYANG BAIKE TOOLS CO., LTD., Zhenjiang (CN)

(72) Inventor: Guoqiang ZHU, Zhenjiang (CN)

(21) Appl. No.: 18/540,340

(22) Filed: Dec. 14, 2023

(30) Foreign Application Priority Data
Dec. 15, 2022 (CN) 202223374900.1

(51) Int. Cl. B23B 51/00; B23B 51/02

(52) U.S. Cl. CPC B23B 51/009; B23B 51/02; B23B 2251/204; B23B 2251/408

(57) ABSTRACT

The present disclosure provides a multi-groove pagoda drill bit. A circumferential wall of a tapered body is provided with a diameter-expanding step increasing in diameter from front to back. A plurality of primary helical grooves extending from a rear end to a front end and a plurality of secondary helical grooves extending from the rear end to close to the front end are opened on the circumferential wall of the tapered body. An axial cutting blade same as a cutting trajectory is disposed on groove mouths of the primary helical grooves and the secondary helical grooves. On a radial section of the tapered body, a front recess segment located at a side of a line connecting an edge tip and an axis and close to the edge tip is disposed in the groove mouths of the primary helical grooves and the secondary helical grooves.

### CROSS-REFERENCE TO RELATED APPLICATION

This application claims priorities from the Chinese patent application 202223374900.1, filed Dec. 15, 2022, the content of which is incorporated herein in the entirety by reference.

### TECHNICAL FIELD

The present disclosure relates to the field of drill bit technologies and in particular to a multi-groove pagoda drill bit.

### BACKGROUND

A tapered step drill bit is a combination tool for drilling circular holes with unequal diameters on thin sheets. Generally, on a circumferential wall of a conventional step drill bit are disposed two helical grooves extending from a front end of the drill bit to a rear end of the drill bit while an oblique cutting blade is disposed on a groove mouth of the helical grooves. But, the step drill bits with such disposal usually swing during operation, reducing the drilling precision. Furthermore, a cutting edge of the oblique cutting blades is not sufficiently sharp and the chip removal of the helical grooves is also unsmooth and tends to be frozen, leading to heating of the drill bit and thus affecting use efficiency and service life.

### SUMMARY

The object of the present disclosure is to provide a multi-groove pagoda drill bit so as to solve the problems of easy heating, low use efficiency and short service life of the drill bit in the prior arts.

The object of the present disclosure can be implemented by employing the following technical solution.

There is provided a multi-groove pagoda drill bit, including a tapered body. A circumferential wall of the tapered body is provided with a diameter-expanding step increasing in diameter from front to back. A plurality of primary helical grooves extending from a rear end to a front end and a plurality of secondary helical grooves extending from the rear end to close to the front end are opened on the circumferential wall of the tapered body. An axial cutting blade same as a cutting trajectory is disposed on groove mouths of the primary helical grooves and the secondary helical grooves. On a radial section of the tapered body, a front recess segment located at a side of a line connecting an edge tip and an axis and close to the edge tip is disposed in the groove mouths of the primary helical grooves and the secondary helical grooves. A recessing depth of the front recess segments relative to the connection lines is 0.1 to 5 mm. In this way, the sharpness of the cutting edges of the axial cutting blades is improved, making the chip removal smoother, reducing the heating of the drill bit, and increasing the drilling efficiency and the service life of the drill bit.

As a further solution of the present disclosure, the recessing depth of the connection lines relative to the front recess segments is 0.1 to 1 mm.

As a further solution of the present disclosure, two primary helical grooves are disposed in an opposed manner.

As a further solution of the present disclosure, two to four secondary helical grooves are disposed in a uniform spacing.

As a further solution of the present disclosure, two primary helical grooves and two secondary helical grooves are disposed in an opposed manner respectively, and the two primary helical grooves and the two secondary helical grooves are disposed in a uniform spacing.

As a further solution of the present disclosure, a handle is disposed at rear end of the tapered body.

As a further solution of the present disclosure, a radial section of the handle is a regular hexagon.

The present disclosure has the following beneficial effects: in the present disclosure, by disposing the front recess segments located at a side of a line connecting an edge tip and an axis and recessed by 0.1 to 5 mm relative to the connection lines in the groove mouths of the primary helical grooves and the secondary helical grooves, the sharpness of the cutting edges of the axial cutting blades can be improved while they are not easily blocked at the cutting edges by iron chips, making the chip removal smoother, reducing the heating of the drill bit and improving the drilling efficiency and the service life of the drill bit.

### BRIEF DESCRIPTIONS OF THE DRAWINGS

Further descriptions are made below to the present disclosure in combination with drawings.

FIG. 1 is a schematic diagram of an entire structure of the present disclosure.

FIG. 2 is a diagram of a radial section of a tapered body according to the present disclosure.

FIG. 3 is a structurally-enlarged diagram of the position A in FIG. 2.

### DETAILED DESCRIPTIONS OF EMBODIMENTS

The technical solutions of the embodiments of the present disclosure will be fully and clearly described below in combination with the drawings of the embodiments of the present disclosure. Apparently, the embodiments described herein are only some embodiments of the present disclosure rather than all embodiments. All other embodiments obtained by those skilled in the arts based on the embodiments of the present disclosure without making creative work shall fall within the scope of protection of the present disclosure.

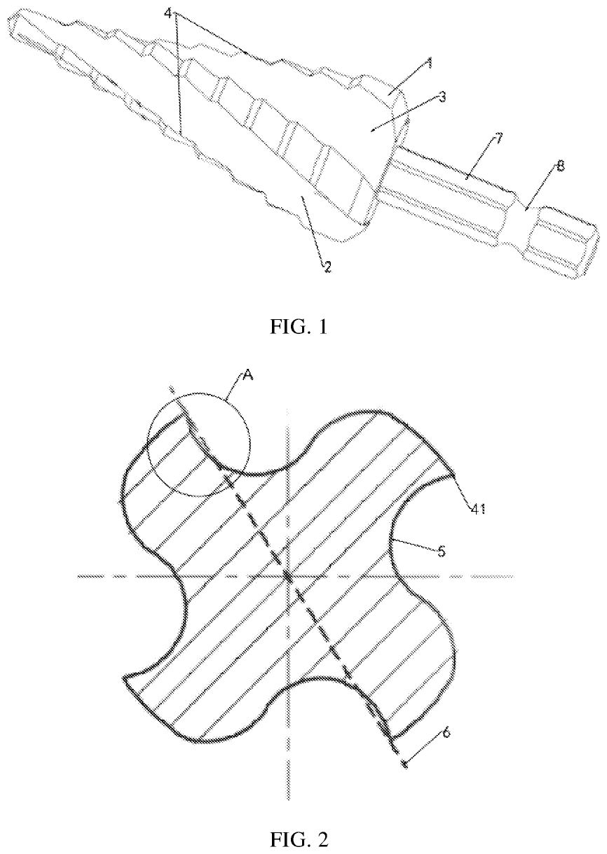

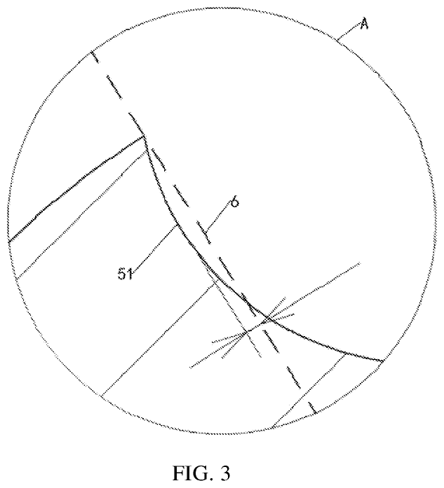

As shown in FIGS. 1 to 3, the present disclosure provides a multi-groove pagoda drill bit, which includes a tapered body 1. On a circumferential wall of the tapered body 1 is disposed a diameter-expanding step increasing in diameter from front to back. Further, a plurality of primary helical grooves 2 extending from a rear end to a front end and a plurality of secondary helical grooves 3 extending from the rear end to close to the front end are opened on the circumferential wall of the tapered body 1. An axial cutting blade 4 same as a cutting trajectory is disposed on a groove mouth 5 of the primary helical grooves 2 and the secondary helical grooves 3. In this way, while the drilling efficiency and the drilling stability of the pagoda drill bit are improved, a sufficient structural strength can be maintained for a head portion of the pagoda drill bit by avoiding small thickness of the head portion of the pagoda drill bit due to extension of the secondary helical grooves 3 to the front end of the pagoda drill bit.

It can be understood that the helical directions of the primary helical grooves 2 and the secondary helical grooves 3 are consistent, that is, both of the two grooves may be positive helixes or reverse helixes.

In one embodiment, two opposed primary helical grooves 2 may be disposed and two to four secondary helical grooves 3 may be disposed in a uniform spacing.

In this embodiment, two primary helical grooves 2 and the two secondary helical grooves 3 are disposed in an opposed manner respectively and the two primary helical grooves 2 and the two secondary helical grooves 3 are disposed in a uniform spacing.

On a radial section of the tapered body 1, one segment of groove mouth 5 substantially shaped like S is formed by each of the primary helical grooves 2 and the secondary helical grooves 3, and an edge tip 41 is formed by the axial cutting blades 4. It can be understood that the front end of the groove mouths 5 is the edge tip 41, and all edge tips 41 on the section are equally distant from an axis of the tapered body 1. The groove mouths 5 have a front recess segment 51 located at a side of a line 6 connecting the edge tips 41 and the axis. The front recess segments 51 are arc-shaped and disposed close to the edge tips 41. Both ends of the front recess segments 51 are respectively intersected with the connection line 6. A recessing depth of the front recess segment relative to the connection line is 0.1 to 5 mm to help chip removal of the primary helical grooves 2 and the secondary helical grooves 3, reduce the heating of the drill bit, and improve the use efficiency and the service life of the drill bit. Preferably, the recessing depth of the front recess segment relative to the connection line is 0.1 to 1 mm.

A handle 7 is disposed at a rear end of the tapered body 1, and preferably, the handle 7 and the tapered body 1 are integrally formed. A radial section of the handle 7 is a regular hexagon and an annular groove 8 is disposed at a middle and rear portion of the handle 7 to facilitate connection of the pagoda drill bit with a cutting driving mechanism.

In conclusion, the drill tip of the pagoda drill bit in the present disclosure maintains the dual-cutting-edge morphology to facilitate the repair and polishing of the users for reuse. In other parts than the drill tip, there are four cutting blades. During hole drilling operations, the stability of the drill bit can be effectively maintained and the recessing depth of the front recess segments 51 in the four helical grooves relative to the connection lines 6 is controlled to 0.1 to 5 mm, improving the sharpness of the cutting edges of the axial cutting blades 4. Thus, they will not be easily blocked at the cutting edges by iron chips during cutting process, making chip removal smoother, reducing the heating of the drill bit and improving the drilling efficiency and the service life of the drill bit.

The present disclosure is detailed with one embodiment but the contents are only about the preferred embodiments of the present disclosure and shall not be considered as limiting the scope of protection of the present disclosure. Equivalent changes and improvements and the like made based on the scope of protection of the present disclosure shall all fall within the scope of protection of the present disclosure.

1-7. (canceled)

8. A multi-groove pagoda drill bit, comprising a tapered body, and a circumferential wall of the tapered body being provided with a diameter-expanding step increasing in diameter from front to back, wherein a plurality of primary helical grooves extending from a rear end to a front end and a plurality of secondary helical grooves extending from the rear end to close to the front end are opened on the circumferential wall of the tapered body, an axial cutting blade same as a cutting trajectory is disposed on groove mouths of the primary helical grooves and the secondary helical grooves, a front recess segment located at a side of a line connecting an edge tip and an axis and close to the edge tip is disposed in the groove mouths of the primary helical grooves and the secondary helical grooves on a radial section of the tapered body, and a recessing depth of the front recess segments relative to the connection lines is 0.1 to 1 mm.

9. The pagoda drill bit of claim 8, wherein two primary helical grooves are disposed in an opposed manner.

10. The pagoda drill bit of claim 8, wherein two to four secondary helical grooves are disposed in a uniform spacing.

11. The pagoda drill bit of claim 8, wherein two primary helical grooves and two secondary helical grooves are disposed in an opposed manner respectively, and the two primary helical grooves and the two secondary helical grooves are disposed in a uniform spacing.

12. The pagoda drill bit of claim 8, wherein a handle is disposed at rear end of the tapered body.

13. The pagoda drill bit of claim 12, wherein a radial section of the handle is a regular hexagon.
